(19) United States
(12) Patent Application Publication
(10) Pub. No.: US 2007/0296548 A1
(43) Pub. Date: Dec. 27, 2007

(54) Resonant circuit tuning system using magnetic field coupled reactive elements

(76) Inventors: Stewart E. Hall, Wellington, FL (US); Richard Herring, Apex, NC (US); Hap Patterson, Boca Raton, FL (US)

Correspondence Address: FRANK CONA;SR. INTELLECTUAL PROPERTY CONUSEL, TYCO FIRE & SECURITY, ONE TOWN CENTER ROAD, BOCA RATON, FL, 33486, US

(21) Appl. No.: 11/475,477

(22) Filed: Jun. 27, 2006

(51) Int. Cl. H04Q 5/22

(52) U.S. Cl. 340/10.1; 340/572.5; 340/572.7; 455/77

(57) ABSTRACT

A resonant circuit tuning system and a method for tuning are provided. The resonant circuit tuning system may include an LCR circuit and a reactive element magnetically coupled to the LCR circuit.

### BACKGROUND OF THE INVENTION

1. Field of the Invention

This invention relates generally to electronic tuning circuits, and more particularly to a tuning system using magnetic field coupled reactive elements.

2. Description of the Related Art

Magnetic fields are used in many electronic systems for a variety of purposes such as Electronic Article Surveillance (EAS), Radio Frequency Identification (RFID), metal detectors, magnetic imaging systems, remote sensing, communications, etc. In these various electronic systems, a magnetic coil may be used as either a transmitter or as a receiver. As a transmitter, the coil is usually employed to project a magnetic field into a desired sensing region. As a receiver, the coil may be placed in a region to receive a signal or to detect the presence of a tag, metal object, etc.

More particularly, for transmitters, a highly efficient method for generating magnetic fields involves the use of a series resonant LCR circuit that presents a low impedance to the transmitter at the transmit frequency. To achieve high magnetic field levels from the antenna of the transmitter, it is desirable for the transmitter to deliver high currents to the antenna coil. Therefore, to achieve high performance, it is desirable to maximize the current delivered from the transmitter into the coil. One method for maximizing the current delivered from the transmitter is to use a LCR circuit with a high quality factor (Q). This may be accomplished by increasing the inductance of the antenna coil and by reducing the total series resistance of the circuit.

For receivers, a different type of tuned resonant circuit is typically used that employs a parallel placement of an inductor, a capacitor and resistance to form a parallel resonant LCR circuit. This type of circuit is used in applications that need high impedance of the coil at resonance, such as, for example, at the input of a receiver for an EAS system, an RFID tag or antenna, or in magnetic field sensing inputs. To achieve high sensitivity for receiver antennas using magnetic coils, it is desirable for the receiver to present a high impedance to and thereby deliver a high voltage signal to the receiver input. One method to achieve this high sensitivity is to increase the Q of the antenna to make the antenna more sensitive to the frequencies of interest for the application. As in the case of the series LCR circuit, it is desirable to have a high Q LCR circuit to take advantage of the higher performance.

There are practical limitations to the use of high Q LCR circuits. In many applications, the resonant frequency (or tuning) of the LCR circuit varies from the ideal either due to design variation, variations in installation environment (e.g., door frames, floor, etc.) or due to dynamic changes in the operating environment. For example, design tolerance variations in tuning may be caused by variations in the construction of the resonant capacitor(s) and variations in the construction of the antenna coil, which affect the inductance and resistance of the LCR circuit, thereby affecting tuning and performance. Additionally, some types of antenna coils use permeable magnetic materials to concentrate or shape the magnetic field from a transmit antenna or to increase the sensitivity of receiver antenna to external magnetic fields. Many of these materials exhibit wide tolerances in magnetic permeability and material losses. Furthermore, these material properties vary with changes in the operating magnetic field flux density, operating temperature, mechanical stresses, etc. Some materials may also change over time during the life of the system. All these changes in material characteristics affect the inductance and the losses of the LCR circuit and affect tuning and performance.

Further, in some applications, an antenna coil may be mounted near magnetically permeable or conductive materials that may alter the magnetic field around the antenna. The altering of the magnetic field can change both the inductance of the coil and the effective resistance of the LCR circuit, thereby affecting the tuning and performance of the LCR circuit. In other applications, during normal operation, the magnetic field of the antenna may be dynamically altered by magnetically permeable or conductive materials moving near the antenna. As a result, this may cause the inductance or effective resistance of the antenna to dynamically change, thereby affecting the tuning and performance of the LCR circuit. Further, several magnetically coupled antennas may be used by a system to dynamically change the orientation of magnetic field vectors generated by a transmit antenna or sensed by a receiver antenna within a sensing region. This dynamic variation is accomplished by changing the relative phase relationships of currents in the various antenna coils and may alter the inductance of the individual antennas due to the mutual inductance (or coupling coefficient) between the coils. As a result, the effective resonant frequency of a coil to dynamically changes with changes in the relative phases of currents in the magnetically coupled coils.

Thus, the use of high Q antennas to achieve high performance of an antenna LCR circuit may be needed or desired. However, high Q antennas are prone to tuning problems. Therefore, adjusting of either the tuning or Q of an LCR circuit in response to changes in, for example, the operating environment may be needed or desired. For example, certain interfering signals may be generated either by a system connected to the LCR circuit, or by external systems, and that may necessitate changes to the antenna tuning or reduction in the Q of the LCR circuit. A means to dynamically adjust the tuning or Q of the LCR circuit to respond to these changes in the operating environment, thus, may be needed or desired.

Known systems and methods for tuning LCR antenna circuits typically add controls and other components that increase the cost of the system and are not always satisfactory in providing needed or desired tuning. For example, it is known to provide a set of capacitors in parallel or series arrangement with switches that may be opened or closed to adjust the effective capacitance of the capacitor bank. However, as the Q of the LCR circuit increases, this method requires an increasing number of tuning capacitors and tuning switches in the capacitor bank to provide a fine tuning capability. Further, as the Q of the LCR circuit increases, the voltage supported by the capacitor bank increases, requiring the tuning capacitors and the tuning switches to be rated for high voltage operation. Finally, because the capacitor bank is in series with the transmitter, the tuning capacitors and tuning switches must support high currents. Thus, as the Q of the LCR circuit increases, the voltage and current increases as well, which requires that the tuning capacitors and tuning switches be rated for high voltage and current operation.

It is also known to provide an LCR tuning system that decreases the magnetic field of an inductor by the presence of one or more single loop windings positioned in proximity to the inductor. Switchable shorted turns are used to vary the magnetic field to fine tune the inductance, which eliminates the need for a capacitor tuning bank. However, closing a switch to short each of the single loop windings can only decrease the magnetic field of the inductor, thereby decreasing the inductance. This allows the resonant frequency of the LCR circuit to only be adjusted higher from the original LCR frequency. Further, the current induced in the single loop windings flows through conductors and switches with finite conductivity as well as the junction voltage of the switch. In many applications, the induced current may dramatically decrease the Q of the LCR circuit. Additionally, because the current flowing in the shorted turn flows in the opposite direction as the main inductor winding, the effective magnetic field is reduced and depending on the application, may degrade the performance of the antenna.

Thus, these known methods often result in a reduction of the Q of the LCR circuit Q and also a reduction in the effective magnetic field. These reductions result in degradation of the performance of the system, for example, a degradation of the performance of an antenna of the system.

### BRIEF DESCRIPTION OF THE INVENTION

In an embodiment, a resonant circuit tuning system is provided that may include an LCR circuit and a reactive element magnetically coupled to the LCR circuit.

In another embodiment, an electronic article surveillance (EAS) system is provided that may include at least one of a transmitter and a receiver and at least one antenna connected to the transmitter or receiver. The EAS system may further include a tuning circuit configured to tune the at least one antenna. The tuning circuit may include at least one reactive element magnetically coupled to the antenna.

In yet another embodiment, a method for tuning an LCR circuit is provided. The method may include magnetically coupling a reactive element to an inductor of the LCR circuit and controlling a resonant frequency of the LCR circuit using the reactive element.

### BRIEF DESCRIPTION OF THE DRAWINGS

For a better understanding of the invention, together with other objects, features and advantages, reference should be made to the following detailed description which should be read in conjunction with the following figures wherein like numerals represent like parts.

FIG. 1 is a block diagram of a resonant circuit tuning system constructed in accordance with an embodiment of the invention having a reactive element.

FIG. 2 is a block diagram of a resonant circuit tuning system constructed in accordance with an embodiment of the invention having a resistive and a capacitive element.

FIG. 3 is a block diagram of a resonant circuit tuning system constructed in accordance with an embodiment of the invention having a resistive and an inductive element.

FIG. 4 is a block diagram of a resonant circuit tuning system constructed in accordance with an embodiment of the invention having a plurality of reactive elements.

FIG. 5 is a block diagram of a resonant circuit tuning system constructed in accordance with an embodiment of the invention having a reactive element and a plurality of taps.

FIG. 6 is a block diagram of a resonant circuit tuning system constructed in accordance with an embodiment of the invention having a plurality of reactive elements and a plurality of magnetically coupled windings.

FIG. 7 is a block diagram of a resonant circuit tuning system constructed in accordance with an embodiment of the invention having a reactive element magnetically coupled to the windings of an LCR circuit.

FIG. 8 is a block diagram of a resonant circuit tuning system constructed in accordance with an embodiment of the invention having a variable inductive element.

FIG. 9 is a block diagram of a resonant circuit tuning system constructed in accordance with an embodiment of the invention having a variable capacitive element.

FIG. 10 is a block diagram of a resonant circuit tuning system constructed in accordance with an embodiment of the invention having a variable capacitive element and a variable resistive element.

FIG. 11 is a block diagram of a resonant circuit tuning system constructed in accordance with an embodiment of the invention having a variable inductive element and a variable resistive element.

### DETAILED DESCRIPTION OF THE INVENTION

For simplicity and ease of explanation, the invention will be described herein in connection with various embodiments thereof. Those skilled in the art will recognize, however, that the features and advantages of the various embodiment of the invention may be implemented in a variety of configurations. It is to be understood, therefore, that the embodiments described herein are presented by way of illustration, not of limitation.

Various embodiments of the invention provide a system and method for tuning an LCR circuit using one or more magnetically coupled reactive elements and/or resistive elements. It should be noted that the tuning system and method may be used in connection with any type of electronic system, for example, in electronic systems wherein a coil is used as either a transmitter or receiver. The tuning system and method also may be used in different types of applications, for example, Electronic Article Surveillance (EAS), Radio Frequency Identification (RFID), metal detectors, magnetic imaging systems, remote sensing, communications, etc. However, the various embodiments may be implemented in other applications for use with different electronic devices as desired or needed.

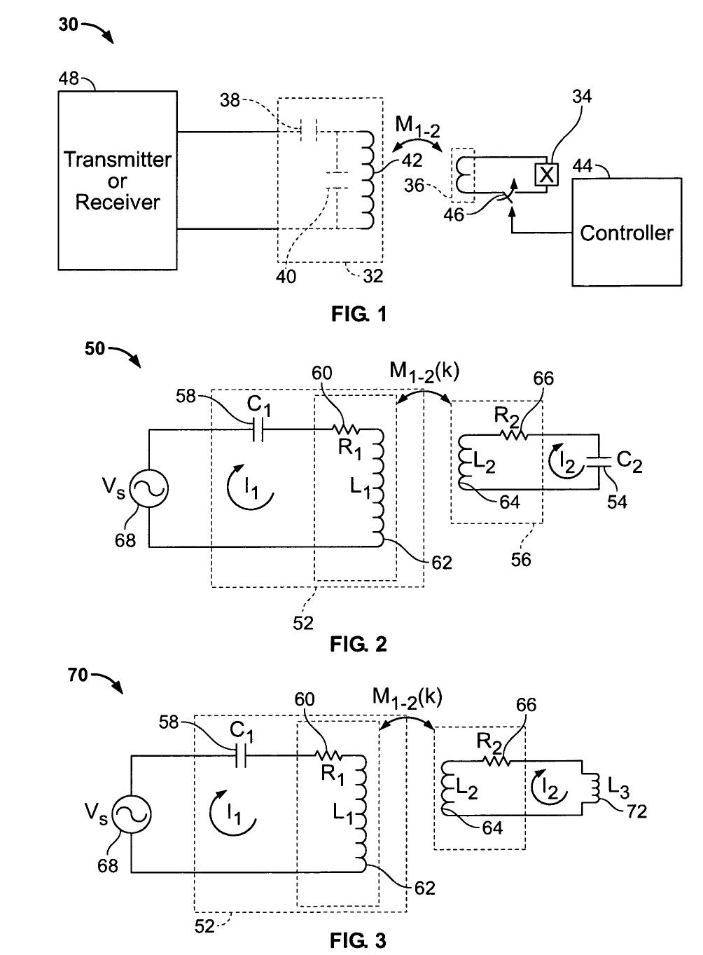

FIG. 1 illustrates a resonant circuit tuning system 30 constructed in accordance with an embodiment of the invention and may include an LCR circuit 32 magnetically coupled to a reactive element 34 with a magnetically coupled winding 36. The LCR circuit 32 may be configured, for example, as a transmitting or receiving antenna, such as, an antenna for an EAS antenna pedestal. Further, the magnetically coupled winding 36 may be any type of magnetically coupled element, for example, any type of magnetic field coupled element. Additionally, the reactive element 34 may be any type of element providing reactance, for example, one or more capacitive elements and/or one or more inductive elements.

The LCR circuit may be a parallel and/or series circuit, and in one embodiment, may include a first capacitive element 38 in series with a parallel combination of a second capacitive element 40 and an inductive element 42. The magnetically coupled winding 36 may include one or more turns that are magnetically coupled to the inductive element 42 of the LCR circuit 32 with the reactive element 34 connected to the magnetically coupled winding 36.

It should be noted that when reference is made herein to a capacitive element, inductive element, resistive element or other element, these elements may be provided, modified or replaced with an equivalent element. For example, when an embodiment is shown having a capacitive element, this may include one or more capacitors or elements providing capacitance. Similarly, and for example, when an embodiment is shown having an inductive element, this may include one or more inductors or elements providing inductance. Also, similarly, and for example, when an embodiment is shown having a resistive element, this may include one or more resistors or elements providing resistance.

The resonant circuit tuning system 30 also may include a controller 44 connected to the reactive element 34 via a switch 46. The controller 44 is configured to control the switch 46, and more particularly, to switch between an on state (connected state) and an off state (disconnected state) to reactively load the LCR circuit 32. The switching of the switch 46 by the controller 44 may be manual, for example, controlled by an operator or user, or may be automatic, for example, controlled by a system controller or program. It should be noted that the switch 46 may be any kind of switching element, for example, switching transistors.

The resonant circuit tuning system 30 also may include and be connected to a communication device 48, for example, a transmitter or receiver. In operation, the switching of the reactive element 34, which may be referred to as a tuning reactance, to reactively load the LCR circuit 32, adjusts the tuning of the LCR circuit 32. The tuning of the communication device 48 connected to the LCR circuit 32 is also thereby adjusted.

FIG. 2 illustrates a resonant circuit tuning system 50 constructed in accordance with another embodiment of the invention and may include an LCR circuit 52 magnetically coupled to a capacitive element 54 (C₂), for example, a loading capacitor via a magnetically coupled winding 56. The LCR circuit 52 may be configured in a series configuration having a capacitive element 58 (C₁), a resistive element 60 (R₁) and an inductive element 62 (L₁). The inductive element 62 is may be referred to as a primary inductance and the capacitive element 58 may be referred to as a resonant capacitance. The magnetically coupled winding 56 may include an inductive element 64 (L₂) and a resistive element 66 (R₂). The inductive element 64 of the magnetically coupled winding 56 is coupled (e.g., magnetically coupled) to the inductive element 62 of the LCR circuit 52 with a coupling coefficient k. The LCR circuit 52 also may be connected to a voltage source 68 (Vₛ).

The operation and operating characteristics of the resonant circuit tuning system 50 will now be described. This description can be similarly applied to the other various embodiments of resonant circuit tuning systems described herein. In particular, the impedance of the LCR circuit 52 at the voltage source 68 is shown in Equation 1:

$$Z = \frac{{V}_{s}}{{I}_{1}} \qquad ( 1 )$$

Solving for Z from Equation 1, a reduced form of Equation 1 results as follows:

$$\begin{matrix}Z = ⌊ {R}_{series} + {R}_{coupled} ⌋ + j \cdot ⌊ {X}_{series} + {X}_{coupled} ⌋ \\ where \text{:} & ( 2 ) \\ {R}_{series} = {R}_{1} & ( 3 ) \\ {R}_{coupled} = \frac{{ω}^{2} \cdot {k}^{2} \cdot {L}_{1} \cdot {L}_{2} \cdot {R}_{2}}{{R}_{2}^{2} + {( ω \cdot {L}_{2} - \frac{1}{ω \cdot {C}_{2}} )}^{2}} & ( 4 ) \\ {X}_{series} = ω \cdot {L}_{1} - \frac{1}{ω \cdot {C}_{1}} & ( 5 ) \\ {X}_{coupled} = - \frac{{ω}^{2} \cdot {k}^{2} \cdot {L}_{1} \cdot {L}_{2} \cdot ( ω \cdot {L}_{2} - \frac{1}{ω \cdot {C}_{2}} )}{{R}_{2}^{2} + {( ω \cdot {L}_{2} - \frac{1}{ω \cdot {C}_{2}} )}^{2}} & ( 6 )\end{matrix}$$

The resonant frequency of the coupled circuit occurs when the total reactance of Equation 2 is zero:

Xₜₒₜₐₗ=Xₛₑᵣᵢₑₛ+X_{coupled}=0 (7)

In operation, and for example, the inductance of the inductive element 64, which in one embodiment is a tuning winding, is selected to have a value much lower than the inductance of the inductive element 62. The capacitive element 54 may be selected to have approximately the same magnitude as the capacitive element 58 and adjusted by a controller (not shown) for tuning purposes to be either greater than or less than the capacitive element 52, for example, as needed or desired for tuning purposes.

If the tuning winding, namely inductive element 64, is open circuited, the resonant frequency of the main winding, namely inductive element 62, will occur when reactance of a series winding Xₛₑᵣᵢₑₛ=0, which occurs at:

$${ω}_{res} = \frac{1}{\sqrt{L 1 \cdot C 1}} \qquad ( 8 )$$

As an example, for typical antenna circuits and tuning windings, the capacitive element 54 dominates both the resistance of the resistive element 66 and the inductive reactance of the inductive element 62 as follows:

$$\begin{matrix}\frac{1}{{ω}_{res} \cdot C 2} ≫ {ω}_{res} \cdot L 2 \\ and & ( 9 ) \\ \frac{1}{{ω}_{res} \cdot C 2} ≫ R 2 & ( 10 ) \\ {X}_{total} ≅ ( ω \cdot {L}_{1} - \frac{1}{ω \cdot {C}_{1}} ) + {ω}^{3} \cdot {k}^{2} \cdot {L}_{1} \cdot {L}_{2} \cdot {C}_{2} & ( 11 )\end{matrix}$$

which reduces to:

$${X}_{total} ≅ {ω}^{2} - \frac{1}{{L}_{1} \cdot {C}_{1}} + {ω}^{4} \cdot {k}^{2} \cdot {L}_{2} \cdot {C}_{2} \qquad ( 12 )$$

Thus, the resonance occurs when Xₜₒₜₐₗ=0. Finding the roots of the equation yields:

$$\begin{matrix}{ω}_{new} ≅ \sqrt{\frac{- 1 + \sqrt{1 + 4 \cdot {k}^{2} \frac{{L}_{2} \cdot {C}_{2}}{{L}_{1} \cdot {C}_{1}}}}{2 \cdot {k}^{2} \cdot {L}_{2} \cdot {C}_{2}}} \\ for k , {L}_{2} , {C}_{2} \neq 0 ; {L}_{2} ≪ {L}_{1} \\ and & ( 13 ) \\ {ω}_{new} = \sqrt{\frac{1}{{L}_{1} \cdot {C}_{1}}} for k = 0 & ( 14 )\end{matrix}$$

Additionally, it can be shown that at the new resonant frequency the resonant impedance is:

Zₜₒₜₐₗ(ω_{new})=R₁+(ω_{new}⁴·k²·L₁·L₂·C₂²)·R₂ (15)

or expressed in terms of the reactances of the mutual inductance and the tuning capacitance:

$$\begin{matrix}{Z}_{total} ( {ω}_{new} ) = {R}_{1} + {( \frac{{X}_{{M}_{12}} ( {ω}_{new} )}{{X}_{{C}_{2}} ( {ω}_{new} )} )}^{2} \cdot {R}_{2} & ( 16 ) \\ where \text{:} {X}_{{M}_{12}} ( ω ) = ω \cdot k \cdot \sqrt{{L}_{1} \cdot {L}_{2}} & ( 17 ) \\ and {X}_{{C}_{2}} ( ω ) = \frac{1}{ω \cdot {C}_{2}} & ( 18 )\end{matrix}$$

### From these equations, it can be seen that the increase of real impedance to the circuit from the resistive element 66 is very small when X_{C2}>>X_{M12}.

In another embodiment as shown in FIG. 3, a resonant circuit tuning system 70 is provided that is similar to the resonant circuit tuning system 50 (shown in FIG. 2), and accordingly, like reference numerals identify like components. Unlike the resonant circuit tuning system 50, the capacitive element 54 may be replaced with an inductive element 72 (L₃). Using a similar analytical technique as described above with respect to the resonant circuit tuning system 50, the impedance at the voltage source 68 is:

$$\begin{matrix}{Z}_{total} = {R}_{series} + {R}_{coupled} + j \cdot [ {X}_{series} + {X}_{reactive} ] \\ where \text{:} & ( 19 ) \\ {R}_{series} = {R}_{1} & ( 20 ) \\ {R}_{coupled} = \frac{{ω}^{2} \cdot {k}^{2} \cdot {L}_{1} \cdot {L}_{2} \cdot {R}_{2}}{{R}_{2}^{2} + {ω}^{2} \cdot {( {L}_{1} + {L}_{2} )}^{2}} & ( 21 ) \\ {X}_{series} = ω \cdot {L}_{1} - \frac{1}{ω \cdot {C}_{1}} & ( 22 ) \\ {X}_{coupled} = - \frac{{ω}^{2} \cdot {k}^{2} \cdot {L}_{1} \cdot {L}_{2} \cdot [ ( ω \cdot {L}_{1} + {L}_{2} ) ]}{{R}_{2}^{2} + {ω}^{2} \cdot {( {L}_{1} + {L}_{2} )}^{2}} & ( 23 )\end{matrix}$$

Again, for many applications, the following assumptions are made:

L₃>>L₂ (24)

and

ω·L₃>>R₂ (25)

solving for the resonant frequency, as described above, results in the following:

$${ω}_{new} ≅ \sqrt{\frac{1}{( 1 - {k}^{2} \cdot \frac{{L}_{2}}{{L}_{3}} ) \cdot {L}_{1} \cdot {C}_{1}}} \qquad ( 26 )$$

and the impedance at the resonant frequency is approximately:

$$\begin{matrix}{Z}_{res} ≅ {R}_{1} + \frac{{k}^{2} \cdot {L}_{1} \cdot {L}_{2} \cdot {R}_{2}}{{L}_{3}^{2}} \\ when & ( 27 ) \\ {L}_{3} ≫ {L}_{2} & ( 28 )\end{matrix}$$

It should be noted that the solution for the resonant frequency of a parallel LCR circuit can be estimated using, for example, circuit simulation software such as SPICE (Simulation Program with Integrated Circuit Emphasis), a product commercially available from many sources, or graphically solving for the impedance.

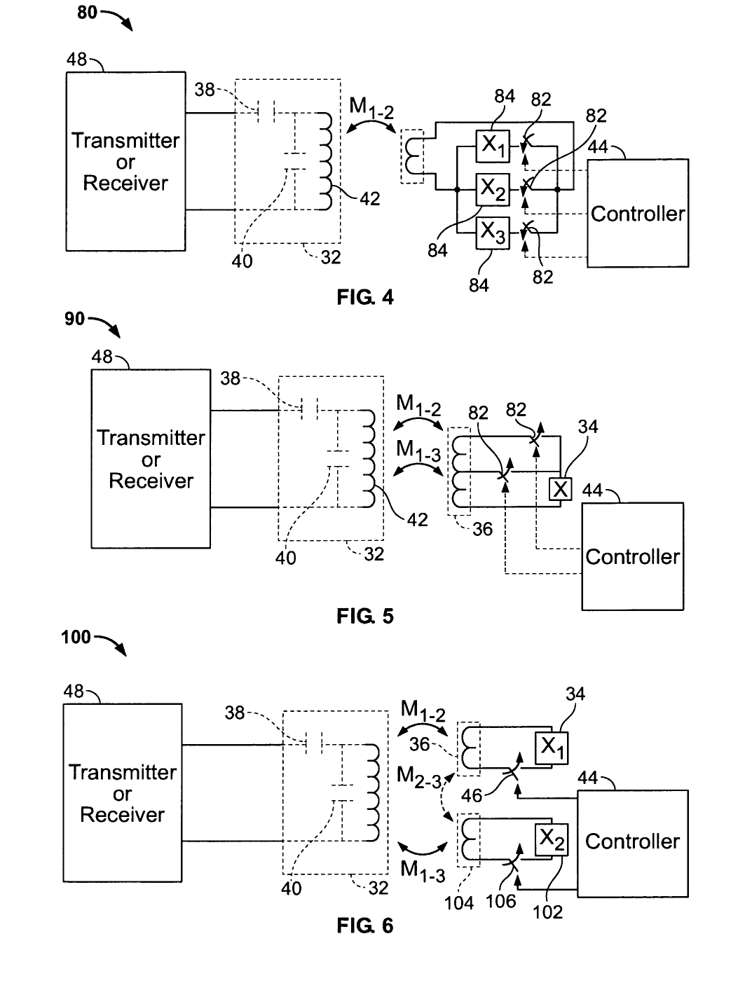

In another embodiment as shown in FIG. 4, a resonant circuit tuning system 80 is provided that is similar to the resonant circuit tuning system 30 (shown in FIG. 1), and accordingly, like reference numerals identify like components. Unlike the resonant circuit tuning system 30, the reactive element 34 may be replaced with a plurality of reactive elements 84. The controller 44 is configured to control a plurality of switches 82, one corresponding to each of the reactive elements 82, and more particularly, to switch between an on state (connected state) and an off state (disconnected state) to reactively load the LCR circuit 32. The switching of the switches 82 by the controller 44 may be manual, for example, controlled by an operator or user, or may be automatic, for example, controlled by a system program.

In another embodiment as shown in FIG. 5, a resonant circuit tuning system 90 is provided that is similar to the resonant circuit tuning system 30 (shown in FIG. 1), and accordingly, like reference numerals identify like components. Unlike the resonant circuit tuning system 30, the reactive element 34 may be connected to a plurality of taps. More particularly, the reactive element 34 may be connected to a plurality of taps 82 that provides tapping of the reactive element 34 to the magnetically coupled winding 36. The tapping allows, for example, for selection of a different number of turns or windings of the magnetically coupled winding 36 to be included in an active portion of the magnetically coupled winding 36. It should be noted that more than one tap 82 with a corresponding switching element may be provided to a single winding.

In operation, the controller 44 connects the reactive element 34 to one or more taps 82 of the magnetically coupled winding 36. Each of the taps 82 provides a different coupling of the reactive element 34 to the LCR circuit 32. The controller 44 may adjust the tuning of the LCR circuit 32 by connecting the reactive element 34 to different taps 82 in the magnetically coupled winding 36.

In another embodiment as shown in FIG. 6, a resonant circuit tuning system 100 is provided that is similar to the resonant circuit tuning system 30 (shown in FIG. 1), and accordingly, like reference numerals identify like components. Unlike the resonant circuit tuning system 30, another reactive element 102 is provided, with the LCR circuit 32 magnetically coupled to the reactive element 102 with a magnetically coupled winding 104. The controller 44 is connected to the reactive element 104 via a switch 106. In this embodiment, the controller 44 is configured to control the switch 46 and switch 106 to adjust tuning of the LCR circuit 32. More particularly, the reactive elements 34 and 102 are magnetically coupled to the LCR circuit 32 with the magnetically coupled winding 36 and the magnetically coupled winding 104, respectively. It should be noted that additional reactive elements may be added to the resonant circuit tuning system 100 in a similar manner.

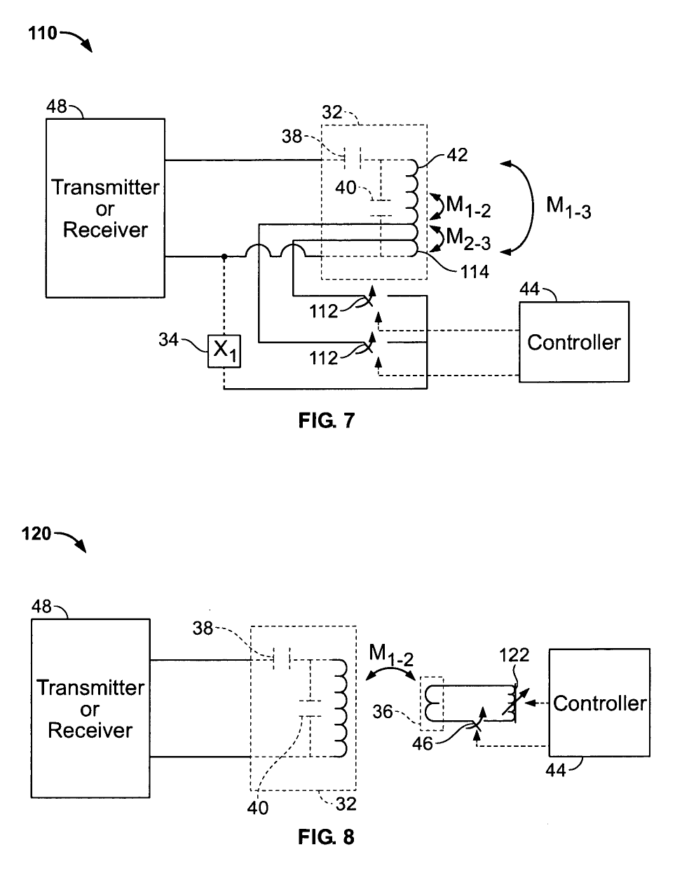

In another embodiment as shown in FIG. 7, a resonant circuit tuning system 110 is provided that is similar to the resonant circuit tuning system 30 (shown in FIG. 1) and accordingly, like reference numerals identify like components. Unlike the resonant circuit tuning system 30, the resonant circuit tuning system 110 includes a plurality of taps 112 on the windings 114 of the inductive element 42 of the LCR circuit 32 and does not include the magnetically coupled winding 36. The reactive element 34 may be connected to the plurality of taps 112 that provide tapping of the reactive element 34 to the windings 114 of the inductive element 42. The tapping allows, for example, for selection of a different number of turns or windings 114 of the inductive element 42 to be included in an active portion of the resonant circuit tuning system 110.

In operation, the controller 44 connects the reactive element 34 to one or more taps 112 of the inductive element 42. Each of the taps 112 provides a different coupling of the reactive element 34 to the LCR circuit 32. The controller 44 may adjust the tuning of the LCR circuit 32 by connecting the reactive element 34 to different taps 112 in the inductive element 42. As an example, the windings of, for example, an antenna may be used in this embodiment to magnetically couple the reactive element 34.

In another embodiment as shown in FIG. 8, a resonant circuit tuning system 120 is provided that is similar to the resonant circuit tuning system 30 (shown in FIG. 1) and accordingly, like reference numerals identify like components. In this embodiment, the reactive element is a variable inductive element, such as a variable inductor 122 and the controller 44 may be configured to control the operation of the switch 46 and to vary the inductance of the variable inductor 122. For example, separate control lines providing separate control signals may be included. In operation, the controller 44 may be configured to switch between an on state (connected state) and an off state (disconnected state) of the variable inductor 122, as well as adjust the inductive value of the variable inductor 122 to provide variable adjustment to the tuning of the LCR circuit 32.

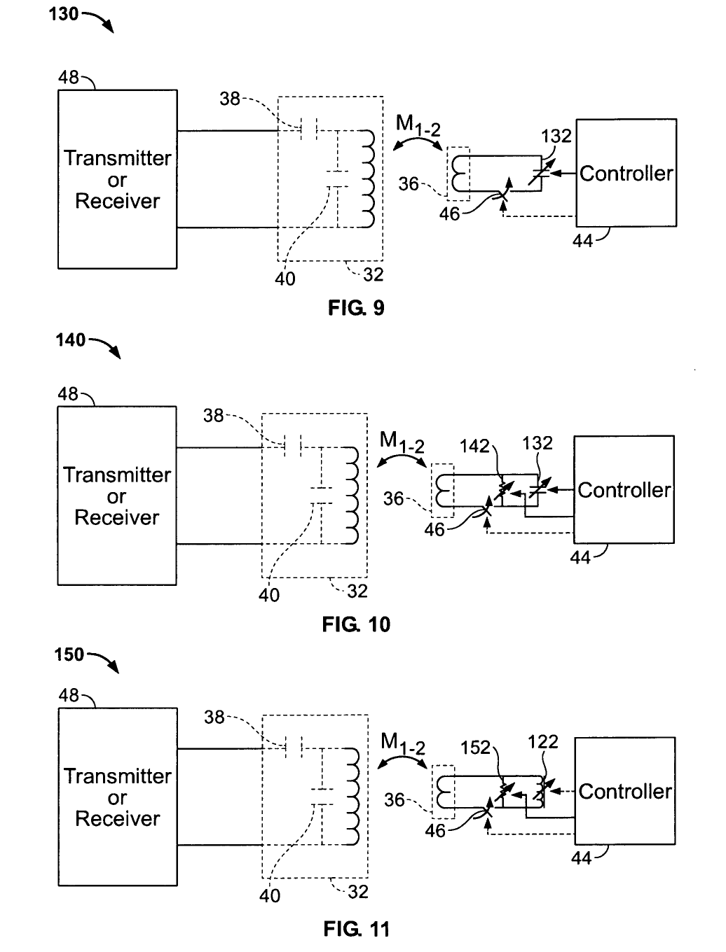

In another embodiment as shown in FIG. 9, a resonant circuit tuning system 130 is provided that is similar to the resonant circuit tuning system 30 (shown in FIG. 1) and accordingly, like reference numerals identify like components. In this embodiment, the reactive element is a variable capacitive element, such as a variable capacitor 132 also referred to as a varactor. In this embodiment, the controller 44 may be configured to control the operation of the switch 46 and to vary the capacitance of the variable capacitor 132. For example, separate control lines providing separate control signals may be included. In operation, the controller 44 may be configured to switch between an on state (connected state) and an off state (disconnected state) of the variable capacitor, as well as adjust the capacitive value of the variable capacitor 132 to provide variable adjustment to the tuning of the LCR circuit 32.

In another embodiment as shown in FIG. 10, a resonant circuit tuning system 140 is provided that is similar to the resonant circuit tuning system 130 (shown in FIG. 9) and accordingly, like reference numerals identify like components. In this embodiment, a variable resistive element, such as a variable resistor 142 is also provided. In this embodiment the controller 44 may be configured to control the operation of the switch 46 and to vary the capacitance of the variable capacitor 132 and the resistance of the variable resistor 142. For example, separate control lines providing separate control signals may be included. In operation, the controller 44 may be configured to switch between an on state (connected state) and an off state (disconnected state) of the variable capacitor 132 and variable resistor 142, which may be provided in a parallel connection. The controller 44 also may be configured to adjust the capacitive value of the variable capacitor 132 and the resistive value of the variable resistor 142 to provide variable adjustment to the tuning of the LCR circuit 32. Specifically, the Q, the resonant frequency, or both of the LCR circuit 32 may be adjusted.

In another embodiment as shown in FIG. 11, a resonant circuit tuning system 150 is provided that is similar to the resonant circuit tuning system 120 (shown in FIG. 8) and accordingly, like reference numerals identify like components. In this embodiment, a variable resistive element, such as a variable resistor 152 is also provided. In this embodiment, the controller 44 may be configured to control the operation of the switch 46 and to vary the inductance of the variable inductor 122 and the resistance of the variable resistive element 152. For example, separate control lines providing separate control signals may be included. In operation, the controller 44 may be configured to switch between an on state (connected state) and an off state (disconnected state) of the variable inductor 122 and variable resistor 152, which may be provided in a parallel connection. The controller 44 also may be configured to adjust the inductive value of the variable inductor 122 and the resistive value of the variable resistor 152 to provide variable adjustment to the tuning of the LCR circuit 32. Specifically, the Q, the resonant frequency, or both of the LCR circuit 32 may be adjusted.

Thus, various embodiments of the invention provide a resonant circuit tuning system wherein one or more of a reactive element, inductive element and resistive element are magnetically coupled to an LCR circuit to provided tuning thereof. The coupled elements may be variable to provide variable adjustment of the Q, resonant frequency, or both of the LCR circuit.

It is to be understood that variations and modifications of the present invention can be made without departing from the scope of the invention. It is also to be understood that the scope of the invention is not to be interpreted as limited to the specific embodiments disclosed herein, but only in accordance with the appended claims when read in light of the forgoing disclosure.

What is claimed is:

1. A resonant circuit tuning system comprising:
an LCR circuit; and
a reactive element magnetically coupled to the LCR circuit.

2. A resonant circuit tuning system in accordance with claim 1 wherein the reactive element comprises at least one of an inductive element and a capacitive element.

3. A resonant circuit tuning system in accordance with claim 1 wherein the reactive element comprises at least one of a variable inductive element and a variable capacitive element.

4. A resonant circuit tuning system in accordance with claim 1 further comprising a resistive element magnetically coupled to the LCR circuit.

5. A resonant circuit tuning system in accordance with claim 4 wherein the resistive element comprises a variable resistive element.

6. A resonant circuit tuning system in accordance with claim 1 wherein the LCR circuit is configured in at least one of a series and a parallel arrangement.

7. A resonant circuit tuning system in accordance with claim 1 further comprising at least one magnetically coupled winding coupling the reactive element to the LCR circuit.

8. A resonant circuit tuning system in accordance with claim 1 further comprising at least one of a transmitter and receiver connected to the LCR circuit.

9. A resonant circuit tuning system in accordance with claim 1 wherein the LCR circuit comprises an antenna configured to provide at least one of transmission and reception.

10. A resonant circuit tuning system in accordance with claim 1 further comprising a controller connected to the reactive element and configured to control the operation of the reactive element.

11. A resonant circuit tuning system in accordance with claim 8 further comprising a switch connected to the controller to control switching of the reactive element.

12. A resonant circuit tuning system in accordance with claim 10 further comprising a plurality of reactive elements.

13. A resonant circuit tuning system in accordance with claim 10 further comprising a plurality of resistive elements

14. A resonant circuit tuning system in accordance with claim 1 further comprising a plurality of taps connecting the reactive element to at least one coil of the LCR circuit.

15. A resonant circuit tuning system in accordance with claim 1 further comprising a plurality of taps connecting the reactive element to at least one coil of the LCR circuit, the plurality of taps connected to an inductor winding of the LCR circuit.

16. A resonant circuit tuning system in accordance with claim 1 wherein the reactive element is magnetically coupled to an inductive winding of the LCR circuit.

17. A resonant circuit tuning system in accordance with claim 1 further comprising a resistive element magnetically coupled to the LCR circuit and a controller configured to control at least one of a resonant frequency and a Q value of the LCR circuit using the reactive element and the resistive element.

18. A resonant circuit tuning system in accordance with claim 1 wherein the LCR circuit is configured to operate in connection with an Electronic Article Surveillance (EAS) system.

19. An electronic article surveillance (EAS) system comprising:
at least one of a transmitter and a receiver;
at least one antenna connected to the at least one transmitter and receiver; and
a tuning circuit configured to tune the at least one antenna, the tuning circuit comprising at least one reactive element magnetically coupled to the antenna.

20. An EAS system in accordance with claim 19 further comprising a controller configured to control at least one of (i) switching the reactive element and (ii) varying a level of the reactive element.

21. An EAS system in accordance with claim 19 wherein the tuning circuit further comprises at least one resistive element magnetically coupled to the antenna.

22. An EAS system in accordance with claim 21 further comprising a controller configured to control at least one of (i) switching the resistive element and (ii) varying a level of the resistive element.

23. A method for tuning an LCR circuit, the method comprising:
magnetically coupling a reactive element to an inductor of the LCR circuit; and
controlling a resonant frequency of the LCR circuit using the reactive element.

24. A method in accordance with claim 23 wherein the magnetically coupling comprises tapping the reactive element to coils of the inductor of the LCR circuit.

25. A method in accordance with claim 23 wherein the LCR circuit further comprises an antenna.

26. A method in accordance with claim 23 further comprising magnetically coupling a resistive element to an inductor of the LCR circuit and controlling a Q value of the LCR circuit using the resistive element.
